(19) United States
(12) Patent Application Publication
(10) Pub. No.: US 2005/0109183 A1
(43) Pub. Date: May 26, 2005

(54) Device for guiding a blade

(76) Inventors: Frederick James Diggle III, Birmingham, AL (US); Shane A. Towles, Birmingham, AL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/718,460

(22) Filed: Nov. 20, 2003

(51) Int. Cl. B23D 49/10

(52) U.S. Cl. 83/745; 83/761; 83/54

(57) ABSTRACT

A device for guiding a blade at a start of a cut is disclosed. The device includes a body member that includes a first surface, a second surface and a third surface bounded by the first and second surfaces. The second surface is opposite the first surface. The third surface includes a curved portion configured to receive a pipe.

### BACKGROUND

The present application is related, generally and in various embodiments, to a device used for guiding a blade at a start of a cut. In the telecommunication and other industries, personnel working at certain jobsites are routinely required to cut pipe to various lengths. For example, electricians are often required to cut conduit to various lengths when provisioning new buildings.

Personnel often use a hacksaw to cut thin-walled conduit to a desired length. However, the blade of the hacksaw can easily drift laterally from the desired cut location when the cut is initiated. When personnel use a hacksaw to cut rigid conduit or large diameter conduit, the drifting of the blade at the start of the cut can be more pronounced. If the cut is not sufficiently precise, the resulting length of pipe can be longer or shorter than the length of pipe that is needed. Inaccurate cuts lead to increased material costs and decreased productivity.

To reduce the chance of the blade drifting when the cut is initiated, many personnel tend to work at a much more deliberate pace at the start of the cut. However, this approach increases the amount of time spent starting a cut, thereby contributing to decreased productivity.

### SUMMARY

In one general respect, this application discloses embodiments of a device for guiding a blade at a start of a cut. According to various embodiments, the device includes a body member that includes a first surface, a second surface and a third surface bounded by the first and second surfaces. The second surface is opposite the first surface. The third surface includes a curved portion configured to receive a pipe.

According to other embodiments, the device includes a body member and a stabilizer member connected to the body member. The body member includes a first surface, a second surface and a third surface bounded by the first and second surfaces. The second surface is opposite the first surface. The third surface includes a curved portion configured to receive a pipe. The stabilizer member includes a first portion, a second portion connected to and extending away from the first portion and a third portion connected to and extending away from the second portion.

Other embodiments of the disclosed invention will be or become apparent to one skilled in the art upon review of the following drawings and detailed description. It is intended that all such additional embodiments be included within this description, be within the scope of the disclosed invention, and be protected by the accompanying claims.

### BRIEF DESCRIPTION OF THE DRAWINGS

FIG. 1 illustrates various embodiments of a device for guiding a blade;

FIG. 2 is a side view of the device of FIG. 1 according to various embodiments;

FIG. 3 illustrates various embodiments of a device for guiding a blade;

FIG. 4 is a side view of the device of FIG. 3 according to various embodiments;

FIG. 5 illustrates various embodiments of the device of FIG. 3 connected to a length of pipe; and

FIG. 6 is a side view of various embodiments of the device of FIG. 3 connected to a length of pipe.

### DETAILED DESCRIPTION

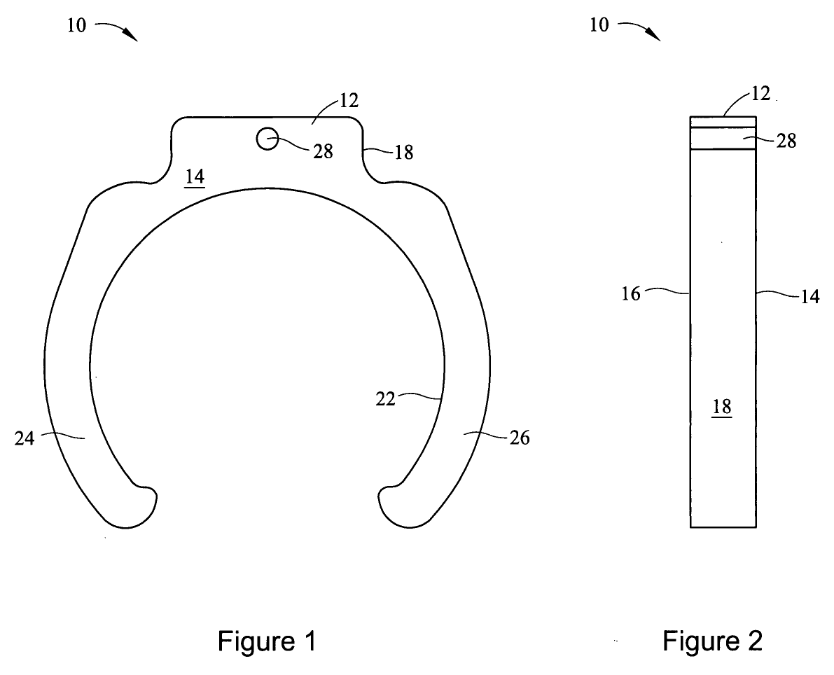

FIGS. 1-2 illustrate various embodiments of a device 10 for guiding a blade at a start of a cut. The device 10 includes a body member 12 that includes a first surface 14, a second surface 16 opposite the first surface 14, and a third surface 18 bounded by the first and second surfaces 14, 16.

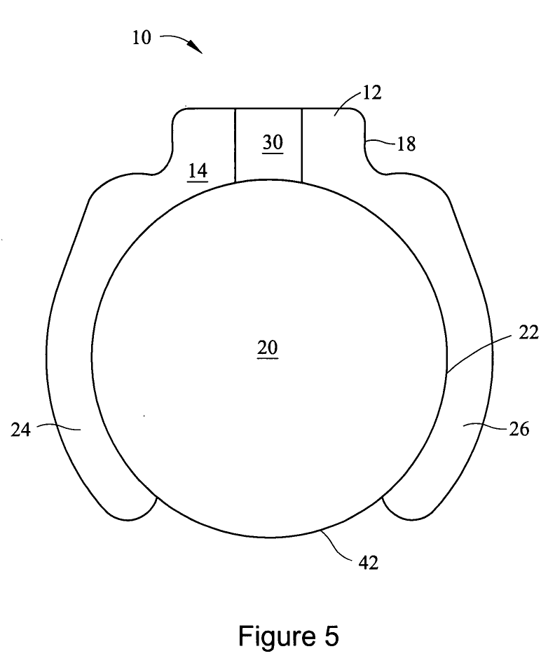

The first surface 14 of the body member 12 is planar. The planarity of the first surface 14 serves as a blade guide for starting a cut through a pipe 20 (shown in FIG. 5). According to various embodiments, the second surface 16 of the body member 12 is also planar. Thus, according to such embodiments, the first and second surfaces 14, 16 of the body member 12 are coplanar.

The third surface 18 includes a curved portion 22 configured to receive the pipe 20. The first, second and third surfaces 14, 16, 18 collectively define a first leg 24 and a second leg 26. The body member 12 is elastic such that the first and second legs 24, 26 return to their original position after being flexed.

The body member 12 also defines an opening 28 that extends from the first surface 14 to the second surface 16. The opening 28 is a cylindrically-shaped opening sized to allow a portion of a key ring to pass therethrough and serves to allow the device 10 to be stored on the key ring.

According to various embodiments, the body member 12 is fabricated from a metal. In one aspect, the body member 12 is magnetized. According to other embodiments, the body member 12 is fabricated from a plastic.

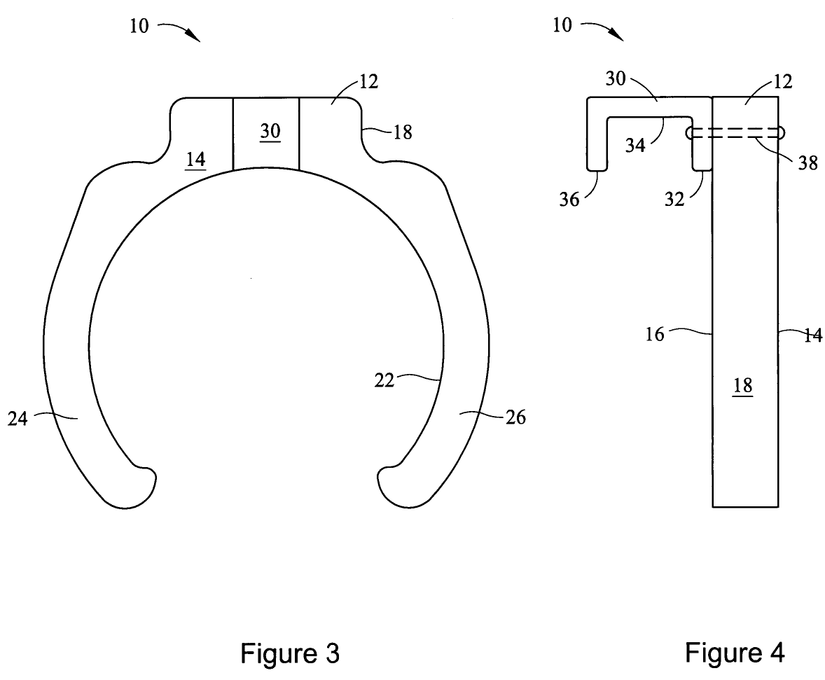

As shown in FIGS. 3 and 4, various embodiments of the device 10 further comprise a stabilizer member 30 connected to the body member 12. The stabilizer member 30 includes a first portion 32 connected to the body member 12, a second portion 34 connected to and extending away from the first portion 32, and a third portion 36 connected to and extending away from the second portion 34. The stabilizer member 30 serves to minimize unwanted movement of the body member 12 when the body member 12 receives the pipe 20.

According to various embodiments, the first portion 32 of the stabilizer member 30 is connected to the second surface 16 of the body member 12 and is oriented substantially parallel to the second surface 16 of the body member 12. The second portion 34 of the stabilizer member 30 is oriented substantially perpendicular to the first portion 32 of the stabilizer member 30. The third portion 36 of the stabilizer member 30 is oriented substantially perpendicular to the second portion 34 of the stabilizer member 30 and substantially parallel to the first portion 32 of the stabilizer member 30.

According to various embodiments, the stabilizer member 30 is connected to the body member 12 with a fastener 38 such as a rivet. According to other embodiments, the stabilizer member 30 is formed integral with the body member 12.

According to various embodiments, the stabilizer member 30 is fabricated from a metal. In one aspect, the stabilizer member 30 is magnetized. According to other embodiments, the stabilizer member 30 is fabricated from a plastic.

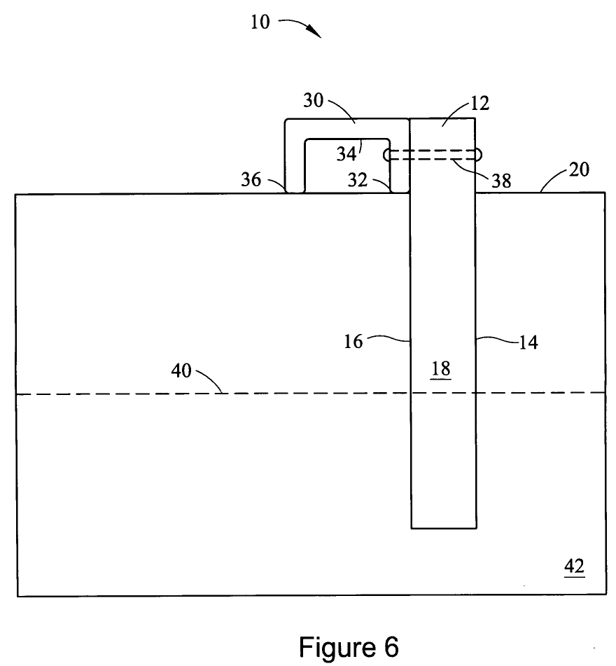

FIGS. 5 and 6 illustrate various embodiments of the device 10 connected to a length of pipe 20. The pipe 20 is a cylindrically shaped pipe that defines an axis 40 (shown in FIG. 6) and includes an outer surface 42. The body member 12 lies in a plane generally perpendicular to the axis 40 and the curved portion 22 of the body member 12 is in contact with and partially surrounds the outer surface 42 of the pipe 20. The third portion 36 of the stabilizer member 30 is in contact with the outer surface 42 of the pipe 20. According to various embodiments, both the first portion 32 and the third portion 36 of the stabilizer member 30 are in contact with the outer surface 42 of the pipe 20.

In use, the first and second legs 24, 26 of the body member 12 are flexed apart to receive the pipe 20. When the pipe 20 is received by the body member 12, the first surface 14 of the body member 12 is positioned proximate the desired cut location. The curved portion 22 of the third surface 18 of the body member 12 partially surrounds and forms a friction fit with the outer surface 42 of the pipe 20. In addition, the third portion 36 of the stabilizer member 30 is in contact with the outer surface 42 of the pipe 20. Once the body member 12 and the stabilizer member 30 are in contact with the pipe 20 as described above, the first surface 14 of the body member 12 can serve as a blade guide for starting a cut in the outer surface 42 of the pipe 20. For example, a planar side portion of a hacksaw blade can be aligned and in contact with the first surface 14 of the body member 12 when the hacksaw blade is used to start a cut in the outer surface 42 of the pipe 20.

While several embodiments of the disclosed invention have been described, it should be apparent, however, that various modifications, alterations and adaptations to those embodiments may occur to persons skilled in the art with the attainment of some or all of the advantages of the disclosed invention. For example, according to various embodiments, a portion of the body member 12 adjacent the opening 28 is bent. It is therefore intended to cover all such modifications, alterations and adaptations without departing from the scope and spirit of the disclosed invention as defined by the appended claims.

1. A device for guiding a blade at a start of a cut, the device comprising:
a body member, wherein the body member includes:
a first surface;
a second surface opposite the first surface; and
a third surface bounded by the first and second surfaces, wherein the third surface includes a curved portion configured to receive a pipe.

2. The device of claim 1, wherein the first surface is planar.

3. The device of claim 2, wherein the second surface is planar.

4. The device of claim 3, wherein the first and second surfaces are coplanar.

5. The device of claim 1, wherein the first, second and third surfaces collectively define first and second legs of the body member.

6. The device of claim 1, wherein the body member defines an opening that extends from the first surface to the second surface.

7. The device of claim 1, wherein the body member is fabricated from a metal.

8. The device of claim 7, wherein the body member is magnetized.

9. The device of claim 1, wherein the body member is fabricated from a plastic.

10. The device of claim 1, wherein the body member is elastic.

11. The device of claim 1, further comprising a stabilizer member connected to the body member.

12. The device of claim 11, wherein the stabilizer member includes:
a first portion connected to the body member;
a second portion connected to and extending away from the first portion; and
a third portion connected to and extending away from the second portion.

13. The device of claim 12, wherein the first portion of the stabilizer member is connected to the second surface of the body member, and wherein the first portion is in contact with the pipe when the body member is connected to the pipe.

14. The device of claim 12, wherein the third portion of the stabilizer member is in contact with the pipe when the body member is connected to the pipe.

15. The device of claim 11, wherein the stabilizer member is connected to the body member with a fastener.

16. The device of claim 15, wherein the fastener is a rivet.

17. The device of claim 11, wherein the stabilizer member is integral with the body member.

18. The device of claim 11, wherein the stabilizer member is fabricated from a metal.

19. The device of claim 18, wherein the stabilizer member is magnetized.

20. The device of claim 11, wherein the stabilizer member is fabricated from a plastic.

21. A device for guiding a blade at a start of a cut, the device comprising:
a body member, wherein the body member includes:
a first surface;
a second surface opposite the first surface; and
a third surface bounded by the first and second surfaces, wherein the third surface includes a curved portion configured to receive a pipe; and
a stabilizer member connected to the body member, wherein the stabilizer member includes:
a first portion;
a second portion connected to and extending away from the first portion; and
a third portion connected to and extending away from the second portion.

22. The device of claim 21, wherein the first portion of the stabilizer member is connected to the second surface of the body member.

23. A device for guiding a blade at a start of a cut, the device comprising:
a first surface;
a second surface opposite the first surface; and
means for receiving a pipe, wherein the means for receiving the pipe are bounded by the first and second surfaces.
